(19) United States
(12) Patent Application Publication
(10) Pub. No.: US 2023/0306265 A1
(43) Pub. Date: Sep. 28, 2023

(54) METHOD AND DEVICE FOR DETERMINING AN OPTIMAL ARCHITECTURE OF A NEURAL NETWORK

(71) Applicant: Robert Bosch GmbH, Stuttgart (DE)

(72) Inventors: Danny Stoll, Freiburg (DE); Frank Hutter, Freiburg Im Breisgau (DE); Simon Schrodi, Freiburg (DE)

(21) Appl. No.: 18/184,379

(22) Filed: Mar. 15, 2023

(30) Foreign Application Priority Data
Mar. 23, 2022 (DE) 10 2022 202 845.7

(51) Int. Cl. G06N 3/082; G06N 3/045

(52) U.S. Cl. CPC G06N 3/082; G06N 3/045

(57) ABSTRACT

A method for determining an optimal architecture of a neural network. The method includes: defining a search space by means of a context-free grammar; training neural networks with candidate architectures on the training data, and validating the trained neural networks on the validation data; initializing a Gaussian process, wherein the Gaussian process comprises a Weisfeiler-Lehman graph kernel; adapting the Gaussian process such that given the candidate architectures, the Gaussian process predicts the validation achieved with these candidate architectures; and performing a Bayesian optimization for finding the candidate architecture that achieved the best performance.

### CROSS REFERENCE

The present application claims the benefit under 35 U.S.C. § 119 of German Patent Application No. DE 10 2022 202 845.7 filed on Mar. 23, 2022, which is expressly incorporated herein by reference in its entirety.

### FIELD

The present invention relates to a method for determining an optimal architecture of a neural network by means of context-free grammar, a training device, a computer program, and a machine-readable storage medium.

### BACKGROUND INFORMATION

The term “neural architecture search” (NAS) is understood to mean that an architecture a∈A that minimizes the following equation is discovered in an automated manner:

$${a}^{*} ∈ arg {min}_{a ∈ A} c ( a , {D}_{train} , {D}_{v a l} )$$

wherein c is a cost function, which a generalization error of the architecture a, which was trained on the training data Dₜᵣₐᵢₙ and was evaluated on the validation data Dᵥₐₗ.

Liu, Hanxiao, et al. “Hierarchical representations for efficient architecture search;” arXiv preprint arXiv:1711.00436 (2017) describe an efficient architecture search for neural networks, wherein their approach combines a novel hierarchical genetic representation scheme that imitates the modular design pattern, and a hierarchical search space that supports complex topologies. Hierarchical search spaces for NAS consist in assembling higher-level motifs from lower-level motifs. This is advantageous because hierarchical search spaces generalize the search spaces for NAS and allow more flexibility in the construction of motifs.

### SUMMARY

The present invention may have the advantage that it allows more general search spaces to be defined and, in addition to a more efficient search in these spaces, also guarantees that the hierarchically assembled motifs are permissible.

Furthermore, the present invention may have the advantage that given the limited resources of the computer, such as memory/energy consumption/computing power, the more general search spaces can discover the optimal architectures that were previously not discoverable.

Further aspects of the present invention are disclosed herein. Advantageous developments and example embodiments of the present invention are disclosed herein.

### SUMMARY

In a first aspect, the present invention relates to a computer-implemented method for determining an optimal architecture of a neural network for a given data set comprising training data and validation data.

According to an example embodiment of the present invention, the method starts with defining a search space that characterizes possible architectures of the neural network by means of context-free grammar. Context-free grammars are, for example, described in the paper: N. Chomsky, “Three models for the description of language”, in IRE Transactions on Information Theory, vol. 2, no. 3, pp. 113-124, September 1956, doi: 10.1109/TIT.1956.1056813 or J. Engelfriet, “Context-free graph grammars”, in Handbook of formal languages, Springer, 1997. Or A. Habel and H.-J. Kreowski, “On context-free graph languages generated by edge replacement”, in Graph-Grammars and Their Application to Computer Science, 1983. It should be noted that a word can be created based on context-free grammar and is given, for example, as a string, wherein the word defines an architecture.

The production rules of the context-free grammars are used to describe a hierarchical search space with several levels. The context-free grammar describes a plurality of hierarchies of levels, wherein the lowest level of the hierarchy defines a plurality of operations. By way of example, the operations may be: convolution of C channels, depthwise convolution, separable convolution of C channels, max-pooling, average-pooling, identity mapping. Parent levels of the hierarchy in each case define at least one rule (also referred to as a production rule) according to which the child levels can be combined with one another or more complex motifs can be assembled from child levels.

This is followed by a random drawing (e.g., uniform sampling) of a plurality of candidate architectures according to the context-free grammar. For this purpose, a word, in particular a string, which can be translated into a syntax tree, is generated according to the grammar. The syntax tree associated with the word is used to generate an edge-attributed graph representing the candidate neural architecture.

This is followed by a training of neural networks with the respective candidate architectures on the training data and a validation of the trained neural networks on the validation data. The training can be with regard to a predetermined criterion: for example, an accuracy.

This is followed by an initialization of a Gaussian process, wherein the Gaussian process comprises/uses a Weisfeiler-Lehman graph kernel. The Weisfeiler-Lehman graph kernel is described in the paper by Ru, Binxin, et al. “Interpretable neural architecture search via bayesian optimisation with weisfeiler-lehman kernels.” arXiv preprint arXiv:2006.07556 (2020).

This is followed by an adaptation of the Gaussian process (GP) such that given the candidate architectures, the GP predicts the validation size achieved with these candidate architectures. The GP receives the candidate architecture as the input variable, which is preferably provided as an attributed directed graph.

This is followed by repeating steps i.-iii. several times. It has been found that (at most 160) repetitions are sufficiently meaningful.
i. Determining the next candidate architecture to be evaluated depending on an acquisition function that depends on the Gaussian process, wherein the acquisition function is optimized by means of an evolutionary algorithm, such as disclosed by McKay in “Grammar-based Genetic Programming: a survey.” An “expected improvement” acquisition function is preferably used as the acquisition function. It should be noted that the determination of the next candidate architecture to be evaluated may alternatively be carried out with a random search and/or with mutations.
ii. Training a further neural network with the candidate architecture to be evaluated on the training data, and validating the further, trained neural network on the validation data.
iii. Adapting the GP such that given the previously used candidate architectures, the GP predicts the validation size achieved with these candidate architectures.

This is finally followed by outputting the candidate architecture that achieved the best performance on the validation data.

According to an example embodiment of the present invention, it is provided that the evolutionary algorithm apply a mutation and crossover, wherein the mutations and crossover are applied to the respective syntax tree characterizing the candidate architecture, wherein a new syntax tree obtained by mutation or crossover is valid according to the context-free grammar. This has the advantage that the candidate architectures always remain valid (i.e., they always remain in the language generated by the grammar), which leads to the manipulated architectures always being executable.

According to an example embodiment of the present invention, it is furthermore provided that instead of a crossover, a self-crossover be carried out randomly, wherein with the self-crossover, branches of the same syntax tree are swapped in the syntax tree. This has the advantageous effect of implicit regularization.

According to an example embodiment of the present invention, it is furthermore provided that the acquisition function be a grammar-guided acquisition function (see, for example, Moss, Henry, et al. “Boss: Bayesian optimization over string spaces.” Advances in neural information processing systems 33 (2020): 15476-15486. (available online: https://arxiv.org/abs/2010.00979 or https://henrymoss.github.io/files/BOSS.pdf)), wherein the acquisition function is evaluated by means of a grammar-guided evolutionary algorithm. Grammar-guided evolutionary algorithms are, for example, described in the paper: McKay, Robert & Hoai, Nguyen & Whigham, P. A. & Shan, Yin & O'Neill, Michael. (2010). Grammar-based Genetic Programming: a survey. Genetic Programming and Evolvable Machines. 11. 365-396. 10.1007/s10710-010-9109-y.

According to an example embodiment of the present invention, it is furthermore provided that resolution changes may be modeled with the aid of context-free grammar. This can be used to search over complete neural architectures. The advantage here is that no test for dimensional deviations is required.

According to an example embodiment of the present invention, it is furthermore provided that the context-free grammar additionally comprises secondary conditions characterizing properties of the architectures. Such a secondary condition may, for example, describe a max. depth, max. number of layers, or max. number of convolutional layers, number of downsampling operations.

Furthermore, according to an example embodiment of the present invention, it is provided that when training the neural networks, a cost function comprises a first function that evaluates a performance capability of the machine learning system with regard to its performance, for example, comprises an accuracy of segmentation, object recognition, or the like and, optionally, a second function that estimates a latency period of the machine learning system depending on a length of the path and the operations of the edges. Alternatively or additionally, the second function may also estimate a computer resource consumption of the path.

In another aspect of the present invention, a computer-implemented method for using the output machine learning system of the first aspect as a classifier for classifying sensor signals is provided. In addition to the steps of the first aspect, the following further steps are carried out here: receiving a sensor signal comprising data from the image sensor, determining an input signal that depends on the sensor signal, and feeding the input signal into the classifier in order to obtain an output signal characterizing a classification of the input signal.

According to an example embodiment of the present invention, the image classifier assigns an input image to one or more classes of a predetermined classification. For example, images of nominally identical products produced in series may be used as input images. For example, the image classifier may be trained to assign the input images to one or more of at least two possible classes representing a quality assessment of the respective product.

The image classifier, e.g., a neural network, may be equipped with a structure such that it can be trained to, for example, identify and distinguish pedestrians and/or vehicles and/or traffic signals and/or traffic lights and/or road surfaces and/or human faces and/or medical abnormalities in imaging sensor images. Alternatively, the classifier, e.g., a neural network, may be equipped with a structure such that it can be trained to identify spoken commands in audio sensor signals.

According to an example embodiment of the present invention, it is furthermore provided that depending on a sensed sensor variable of a sensor, the output neural network determines an output variable depending on which a control variable can then be determined by means of a control unit, for example.

The control variable may be used to control an actuator of a technical system. For example, the technical system may be an at least semiautonomous machine, an at least semiautonomous vehicle, a robot, a tool, a machine tool, or a flying object such as a drone. For example, the input variable may be determined based on sensed sensor data and may be provided to the machine learning system. The sensor data may be sensed by a sensor, such as a camera, of the technical system or may alternatively be received externally.

In further aspects, the present invention relates to a device and to a computer program, which are each configured to carry out the above methods, and to a machine-readable storage medium in which said computer program is stored.

Example embodiments of the present invention are explained in greater detail below with reference to the figures.

### BRIEF DESCRIPTION OF THE DRAWINGS

FIG. 1 schematically illustrates a flow chart of one example embodiment of the present invention.

FIG. 2 schematically illustrates an embodiment example for controlling an at least semiautonomous robot.

FIG. 3 schematically illustrates an embodiment example for controlling a production system, according to the present invention.

FIG. 4 schematically illustrates an embodiment example for controlling an access system, according to the present invention.

FIG. 5 schematically illustrates an embodiment example for controlling a monitoring system, according to the present invention.

FIG. 6 schematically illustrates an embodiment example for controlling a personal assistant, according to the present invention.

FIG. 7 schematically illustrates an embodiment example for controlling a medical imaging systems, according to the present invention.

FIG. 8 schematically illustrates a training device, according to the present invention.

### DETAILED DESCRIPTION OF EXAMPLE EMBODIMENT

A neural architecture is a functional composition of operations, e.g., convolutions or other functions. It is convention to represent neural architectures as computational graphs with an edge-attributed DAG with a single source and a single sink, wherein we associate the edges with the operations and the nodes with the latent representations.

In order to depict (hierarchical) search spaces for NAS, a use of CFGs is proposed, which has the advantage that hierarchical search spaces can be presented in a compact way with CFGs. They define the valid space of neural architectures and rules for the selection and development of neural architectures. While neural architectures are efficiently randomly generated, mutated, and represented in the character string space, the graph space operates implicitly because each character string represents the computational graph of the neural architecture.

Below, it is explained how hierarchical search spaces can be represented with CFGs and how a string representation can be transformed in the corresponding computational graphs according to the CFG of a neural architecture.

Terminal symbols of the CFG are associated with either topologies or primitive operations, wherein the non-terminal symbols allow hierarchical structures to be generated recursively. The production rules describe the assembly process and the evolution of neural architectures in the generated search space (i.e., a domain-specific language of neural architectures). This allows complex higher-level motifs to be assembled from simple lower-level motifs.

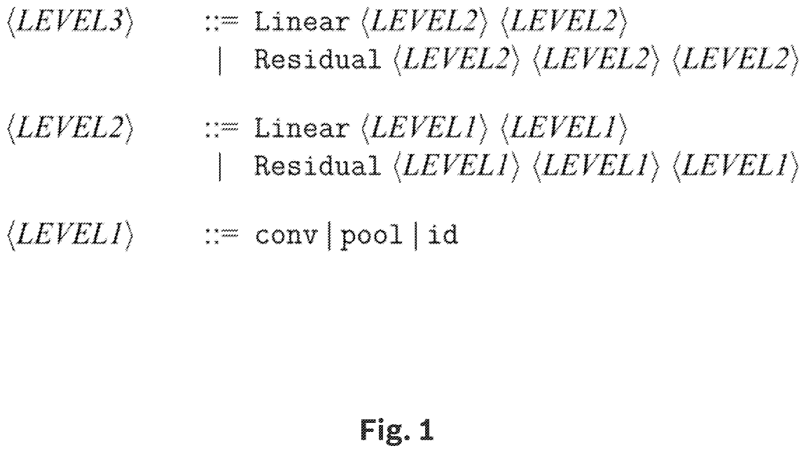

FIG. 1 shows one example embodiment of a CFG grammar comprising 3 levels. Level 1 defines the operations, while the higher levels each describe a possible combination of the underlying levels.

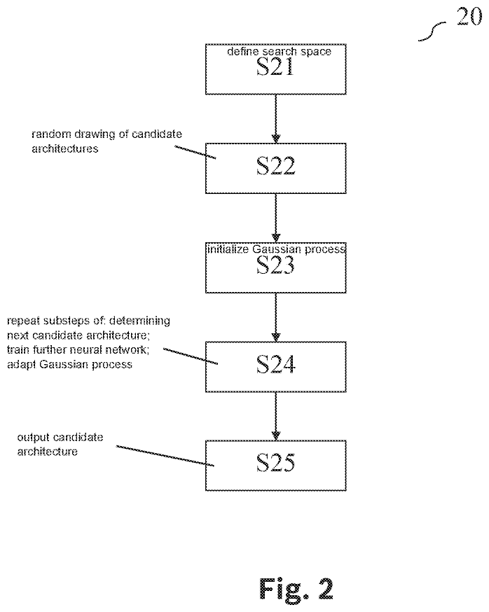

FIG. 2 shows a flow chart 20 of an example embodiment of the present invention for determining an optimal architecture of a neural network for a given data set.

Defining a search space (S21), which characterizes possible architectures of the neural network, by means of a context-free grammar, wherein the context-free grammar characterizes a plurality of hierarchies of levels, wherein the lowest level of the hierarchy defines a plurality of operations, wherein parent levels of the hierarchy define at least one rule, according to which the child levels are assembled or can be combined with one another.

This is followed by a random drawing (S22) of a plurality of candidate architectures according to the context-free grammar. As well as a training of neural networks with the candidate architectures on the training data and a validation of the trained neural networks on the validation data.

This is followed by an initialization (S23) of a Gaussian process, wherein the Gaussian process comprises a Weisfeiler-Lehman graph kernel. As well as an adaptation of the Gaussian process (GP) such that given the candidate architectures, the Gaussian process predicts the validation achieved with these candidate architectures.

In step S24, the sub-steps are repeated several times:
determining the next candidate architecture to be evaluated depending on an acquisition function that depends on the Gaussian process, wherein the acquisition function is optimized by means of an evolutionary algorithm,
training a further neural network with the candidate architecture to be evaluated on the training data, and validating the further, trained neural network on the validation data, and
adapting the Gaussian process such that given the previously used candidate architectures, the Gaussian process predicts the validation achieved with these candidate architectures.

After the repetitions in step S24 were ended, this is finally followed by outputting (S25) the candidate architecture, in particular associated trained neural networks, that achieved the best performance on the validation data.

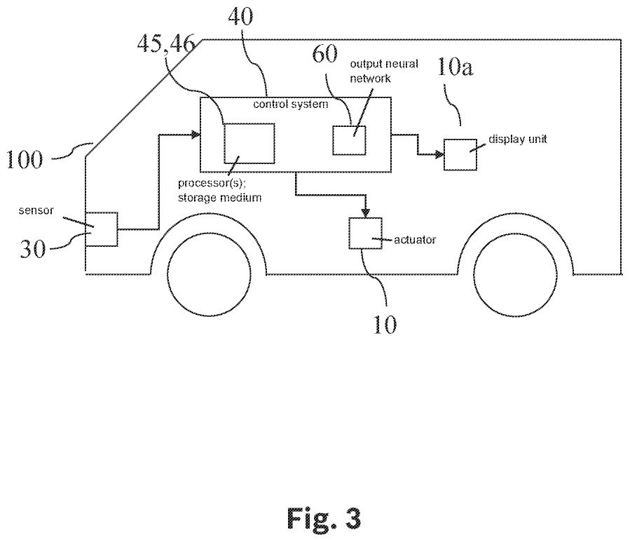

FIG. 3 schematically shows an actuator comprising a control system 40. At preferably regular intervals, an environment 20 of the actuator 10 is sensed by means of a sensor 30, in particular an imaging sensor, such as a video sensor, which may also be given by a plurality of sensors, e.g., a stereo camera. Other imaging sensors are also possible, such as radar, ultrasound, or lidar. A thermal imaging camera is also possible. The sensor signal S, or one sensor signal S each in the case of several sensors, of the sensor 30 is transmitted to the control system 40. The control system 40 thus receives a sequence of sensor signals S. The control system 40 determines therefrom control signals A, which are transmitted to an actuator 10. The actuator 10 can translate received control commands into mechanical movements or changes of physical variables. The actuator 10 can, for example, translate the control command A into an electrical, hydraulic, pneumatic, thermal, magnetic, and/or mechanical movement or cause change. Specific but non-limiting examples include electric motors, electroactive polymers, hydraulic cylinders, piezoelectric actuators, pneumatic actuators, servomechanisms, solenoids, stepper motors, etc.

The control system 40 receives the sequence of sensor signals S of the sensor 30 in an optional reception unit 50, which converts the sequence of sensor signals S into a sequence of input images x (alternatively, the sensor signal S can also respectively be immediately adopted as an input image x). For example, the input image x may be a section or a further processing of the sensor signal S. The input image x comprises individual frames of a video recording. In other words, input image x is determined depending on the sensor signal S. The sequence of input images x is supplied to the neural network 60 output in step S25.

The output neural network 60 is preferably parameterized by parameters stored in and provided by a parameter memory.

The output neural network 60 determines output variables y from the input images x. These output variables y may in particular comprise classification and/or semantic segmentation of the input images x. Output variables y are supplied to an optional conversion unit 80, which therefrom determines control signals A, which are supplied to the actuator 10 in order to control the actuator 10 accordingly. Output variable y comprises information about objects that were sensed by the sensor 30.

The actuator 10 receives the control signals A, is controlled accordingly, and carries out a corresponding action. The actuator 10 can comprise a control logic (not necessarily structurally integrated) which determines, from the control signal A, a second control signal by means of which the actuator 10 is then controlled.

In further embodiments, the control system 40 comprises the sensor 30. In yet further embodiments, the control system 40 alternatively or additionally also comprises the actuator 10.

In further preferred embodiments, the control system 40 comprises a single or a plurality of processors 45 and at least one machine-readable storage medium 46 in which instructions are stored that, when executed on the processors 45, cause the control system 40 to carry out the method according to the present invention.

In alternative embodiments, as an alternative or in addition to the actuator 10, a display unit 10a is provided, which can indicate an output variable of the control system 40.

In a preferred embodiment of FIG. 2, the control system 40 is used to control the actuator, which is here one of an at least semiautonomous robot, here of an at least semiautonomous motor vehicle 100. The sensor 30 may, for example, be a video sensor preferably arranged in the motor vehicle 100.

The actuator 10, preferably arranged in the motor vehicle 100, may, for example, be a brake, a drive, or a steering of the motor vehicle 100. The control signal A may then be determined in such a way that the actuator or actuators 10 is controlled in such a way that, for example, the motor vehicle 100 prevents a collision with the objects reliably identified by the artificial neural network 60, in particular if they are objects of specific classes, e.g., pedestrians.

Alternatively, the at least semiautonomous robot may also be another mobile robot (not shown), e.g., one that moves by flying, swimming, diving, or walking. For example, the mobile robot may also be an at least semiautonomous lawnmower or an at least semiautonomous cleaning robot. Even in these cases, the control signal A can be determined in such a way that drive and/or steering of the mobile robot are controlled in such a way that the at least semiautonomous robot, for example, prevents a collision with objects identified by the artificial neural network 60.

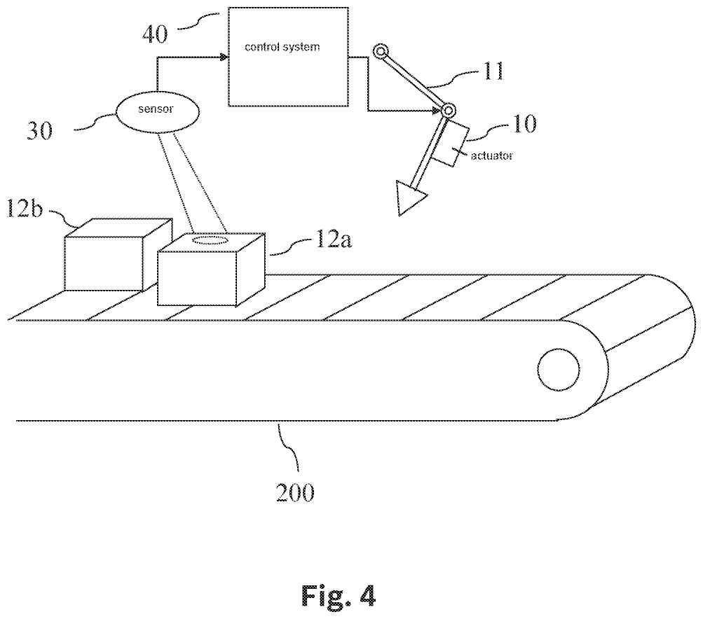

FIG. 4 shows an exemplary embodiment in which the control system 40 is used to control a production machine 11 of a production system 200 by controlling an actuator 10 controlling said production machine 11. For example, the production machine 11 may be a machine for punching, sawing, drilling, milling, and/or cutting.

The sensor 30 may then, for example, be an optical sensor that, for example, senses properties of manufacturing products 12a, 12b. It is possible that these manufacturing products 12a, 12b are movable. It is possible that the actuator 10 controlling the production machine 11 is controlled depending on an assignment of the sensed manufacturing products 12a, 12b so that the production machine 11 carries out a subsequent machining step of the correct one of the manufacturing products 12a, 12b accordingly. It is also possible that, by identifying the correct properties of the same one of the manufacturing products 12a, 12b (i.e., without misassignment), the production machine 11 accordingly adjusts the same production step for machining a subsequent manufacturing product.

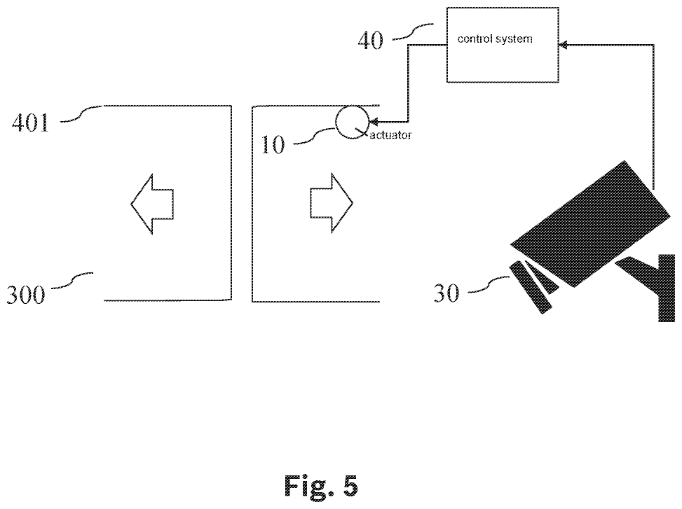

FIG. 5 shows an exemplary embodiment in which the control system 40 is used to control an access system 300. The access system 300 may comprise a physical access control, e.g., a door 401. Video sensor 30 is configured to sense a person. By means of the object identification system 60, this captured image can be interpreted. If several persons are sensed simultaneously, the identity of the persons can be determined particularly reliably by associating the persons (i.e., the objects) with one another, e.g., by analyzing their movements. The actuator 10 may be a lock that, depending on the control signal A, releases the access control, or not, e.g., opens the door 401, or not. For this purpose, the control signal A may be selected depending on the interpretation of the object identification system 60, e.g., depending on the determined identity of the person. A logical access control may also be provided instead of the physical access control.

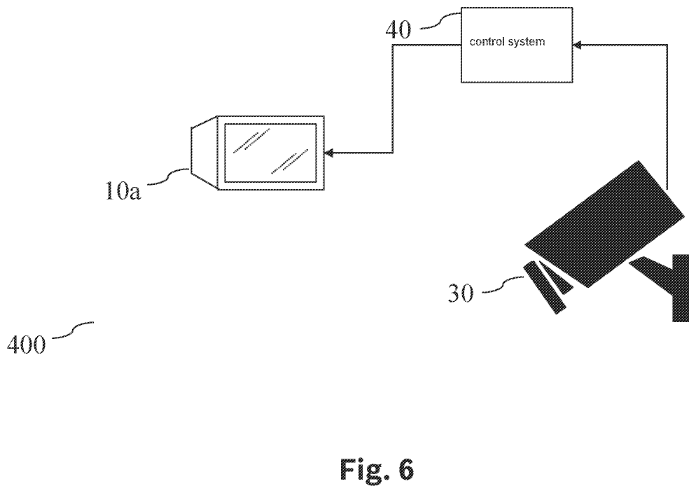

FIG. 6 shows an exemplary embodiment in which the control system 40 is used to control a monitoring system 400. From the exemplary embodiment shown in FIG. 5, this exemplary embodiment differs in that instead of the actuator 10, the display unit 10a is provided, which is controlled by the control system 40. For example, the artificial neural network 60 can reliably determine an identity of the objects captured by the video sensor 30, in order to, for example, infer depending thereon which of them are suspicious, and the control signal A can then be selected in such a way that this object is shown highlighted in color by the display unit 10a.

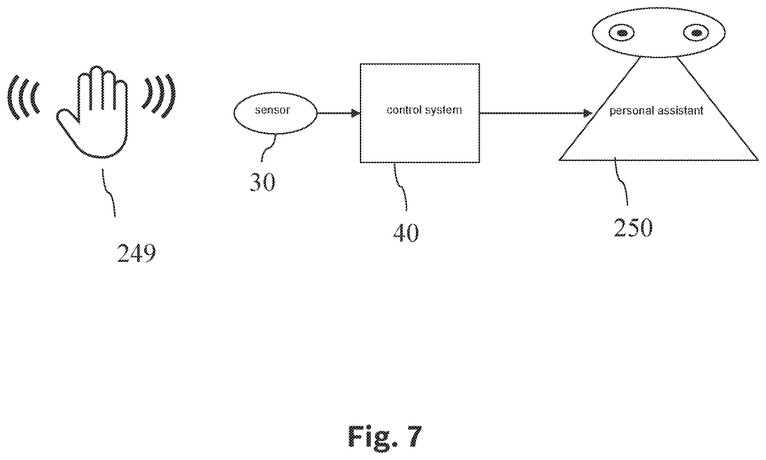

FIG. 7 shows an exemplary embodiment in which the control system 40 is used to control a personal assistant 250. The sensor 30 is preferably an optical sensor that receives images of a gesture of a user 249.

Depending on the signals of the sensor 30, the control system 40 determines a control signal A of the personal assistant 250, e.g., by the neural network performing gesture recognition. This determined control signal A is then transmitted to the personal assistant 250 and the latter is thus controlled accordingly. This determined control signal A may in particular be selected to correspond to a presumed desired control by the user 249. This presumed desired control can be determined depending on the gesture recognized by the artificial neural network 60. Depending on the presumed desired control, the control system 40 can then select the control signal A for transmission to the personal assistant 250 and/or select the control signal A for transmission to the personal assistant according to the presumed desired control 250.

This corresponding control may, for example, include the personal assistant 250 retrieving information from a database and receptably rendering it to the user 249.

Instead of the personal assistant 250, a domestic appliance (not shown) may also be provided, in particular a washing machine, a stove, an oven, a microwave or a dishwasher, in order to be controlled accordingly.

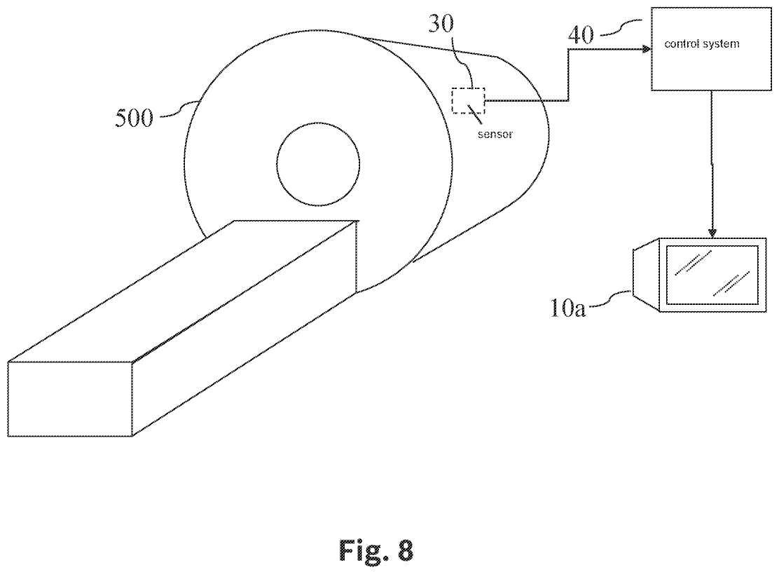

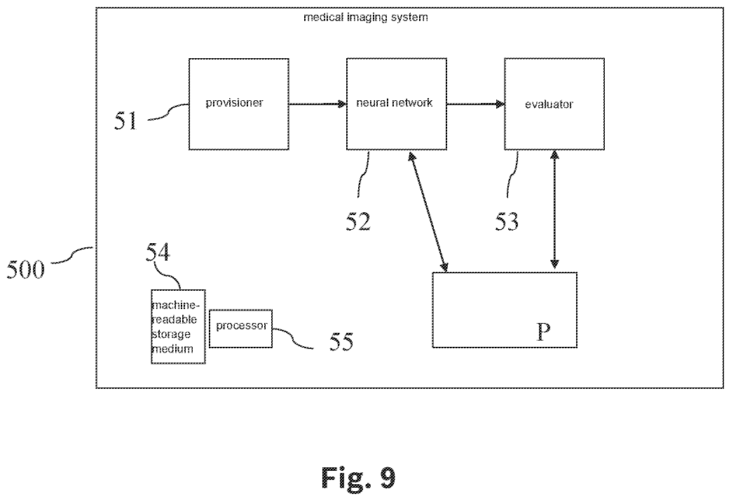

FIG. 8 shows an exemplary embodiment in which the control system 40 is used to control a medical imaging system 500, e.g., an MRT, X-ray, or ultrasound device. For example, the sensor 30 may be given by an imaging sensor, and the display unit 10a is controlled by the control system 40. For example, the neural network 60 may determine whether an area captured by the imaging sensor is abnormal, and the control signal A may then be selected in such a way that this area is presented highlighted in color by the display unit 10a.

FIG. 9 schematically shows a training device 500 comprising a provisioner 51 that provides input images from a training data set. The input images are supplied to the neural network 52 to be trained, which determines output variables therefrom. Output variables and input images are supplied to an evaluator 53, which determines updated parameters therefrom, which are transmitted to the parameter memory P and replace the current parameters there. The evaluator 53 is configured to carry out steps S23 and/or S24 of the method according to FIG. 2.

The methods carried out by the training device 500 may be stored, implemented as a computer program, in a machine-readable storage medium 54 and may be executed by a processor 55.

The term “computer” comprises any device for processing pre-determinable calculation rules. These calculation rules may be present in the form of software, in the form of hardware or also in a mixed form of software and hardware.

What is claimed is:

1. A method for determining an optimal architecture of a neural network for a given data set including training data and validation data, the method comprising the following steps:
defining a search space which characterizes possible architectures of the neural network using a context-free grammar, wherein the context-free grammar characterizes a plurality of hierarchies of levels, wherein a lowest level of each hierarchy defines a plurality of operations, and wherein parent levels of each hierarchy define at least one rule, according to which child levels can be combined with one another;
randomly drawing a plurality of candidate architectures according to the context-free grammar;
training neural networks with the candidate architectures on the training data, and validating the trained neural networks on the validation data;
initializing a Gaussian process, wherein the Gaussian process includes a Weisfeiler-Lehman graph kernel;
adapting the Gaussian process such that given the candidate architectures, the Gaussian process predicts the validation achieved with the candidate architectures;
repeating steps i.-iii. several times:
i. determining a next candidate architecture to be evaluated depending on an acquisition function that depends on the Gaussian process, wherein the acquisition function is optimized using an evolutionary algorithm,
ii. training a further neural network with the candidate architecture to be evaluated on the training data, and validating the further, trained neural network on the validation data, and
iii. adapting the Gaussian process such that given previously used candidate architectures, the Gaussian process predicts the validation achieved with the previously used candidate architectures;
outputting the candidate architecture that achieved a best performance on the validation data.

2. The method according to claim 1, wherein the evolutionary algorithm applies a mutation and crossover, wherein the mutation and crossover are applied to a syntax tree characterizing the candidate architecture, wherein a new syntax tree obtained by the mutation or the crossover is tested according to the context-free grammar.

3. The method according to claim 1, wherein the evolutionally algorithm applies a mutation and a self-crossover, wherein the mutation and self=crossover are applied to a syntax tree charactering the candidate architecture, wherein a new syntax tree is obtained by the mutation or the self-crossover is tested according to the context-free grammar, wherein the self-crossover is carried out randomly, wherein with the self-crossover, branches are swapped in the syntax tree.

4. The method according to claim 1, wherein the acquisition function is a grammar-guided acquisition function, wherein the acquisition function is evaluated using a grammar-guided evolutionary algorithm.

5. The method according to claim 1, wherein a lowest level of the context-free grammar includes a downsampling operation.

6. The method according to claim 1, wherein the context-free grammar additionally includes secondary conditions that characterize properties of the architectures.

7. The method according to claim 1, wherein input variables are images and the machine learning system is an image classifier.

8. A device configured to determine an optimal architecture of a neural network for a given data set including training data and validation data, the device configured to:
define a search space which characterizes possible architectures of the neural network using a context-free grammar, wherein the context-free grammar characterizes a plurality of hierarchies of levels, wherein a lowest level of each hierarchy defines a plurality of operations, and wherein parent levels of each hierarchy define at least one rule, according to which child levels can be combined with one another;
randomly draw a plurality of candidate architectures according to the context-free grammar;
train neural networks with the candidate architectures on the training data, and validate the trained neural networks on the validation data;
initialize a Gaussian process, wherein the Gaussian process includes a Weisfeiler-Lehman graph kernel;
adapt the Gaussian process such that given the candidate architectures, the Gaussian process predicts the validation achieved with the candidate architectures;
repeating i.-iii. several times:
i. determine a next candidate architecture to be evaluated depending on an acquisition function that depends on the Gaussian process, wherein the acquisition function is optimized using an evolutionary algorithm,
ii. train a further neural network with the candidate architecture to be evaluated on the training data, and validating the further, trained neural network on the validation data, and
iii. adapt the Gaussian process such that given previously used candidate architectures, the Gaussian process predicts the validation achieved with the previously used candidate architectures;
output the candidate architecture that achieved a best performance on the validation data.

9. The device as recited in claim 8, wherein the device is a training device.

10. A non-transitory machine-readable storage medium on which is stored a computer program determining an optimal architecture of a neural network for a given data set including training data and validation data, the computer program, when executed by a computer, causing the computer to perform the following steps:
defining a search space which characterizes possible architectures of the neural network using a context-free grammar, wherein the context-free grammar characterizes a plurality of hierarchies of levels, wherein a lowest level of each hierarchy defines a plurality of operations, and wherein parent levels of each hierarchy define at least one rule, according to which child levels can be combined with one another;
randomly drawing a plurality of candidate architectures according to the context-free grammar;
training neural networks with the candidate architectures on the training data, and validating the trained neural networks on the validation data;
initializing a Gaussian process, wherein the Gaussian process includes a Weisfeiler-Lehman graph kernel;
adapting the Gaussian process such that given the candidate architectures, the Gaussian process predicts the validation achieved with these candidate architectures;
repeating steps i.-iii. several times:
i. determining a next candidate architecture to be evaluated depending on an acquisition function that depends on the Gaussian process, wherein the acquisition function is optimized using an evolutionary algorithm,
ii. training a further neural network with the candidate architecture to be evaluated on the training data, and validating the further, trained neural network on the validation data, and
iii. adapting the Gaussian process such that given previously used candidate architectures, the Gaussian process predicts the validation achieved with the previously used candidate architectures;
outputting the candidate architecture that achieved a best performance on the validation data.
